(19) United States
(12) Patent Application Publication
(10) Pub. No.: US 2026/0051924 A1
(43) Pub. Date: Feb. 19, 2026

(54) SEMICONDUCTOR DEVICE FOR REDUCING CROSSTALK NOISE

(71) Applicants: SK hynix Inc., Icheon-si (KR); Seoul National University R&DB Foundation, Seoul (KR)

(72) Inventors: Sangouk JEON, Seoul (KR); Seoyoon Jang, Seoul (KR); Dongsuk Jeon, Seoul (KR); Hankyu Chi, Icheon-si (KR); Wookjin Shin, Icheon-si (KR); Changhyun Pyo, Icheon-si (KR)

(21) Appl. No.: 18/930,536

(22) Filed: Oct. 29, 2024

(30) Foreign Application Priority Data
Aug. 16, 2024 (KR) 10-2024-0109802

(51) Int. Cl. H04B 3/32; H04B 3/06; H04L 25/03

(52) U.S. Cl. CPC H04B 3/32; H04B 3/06; H04L 25/03057

(57) ABSTRACT

A semiconductor device includes a first encoding circuit encoding data to generate encoding data including one or more symbol groups, each of the symbol groups including an upper symbol and a lower symbol; and a second encoding circuit generating transmission data by performing an operation on previous transmission data and the encoding data. The first encoding circuit encodes the data to prevent a signal on each of one or more of aggressor lines from transitioning when a signal on a victim line transitions. A plurality of data lines of the semiconductor device are arranged in a grid pattern, the victim line is a data line included in an inner row among the plurality of data lines, and each of the aggressor lines is a data line located adjacent the victim line. The upper symbol corresponds to the victim line and the lower symbol corresponds to the aggressor lines.

### CROSS-REFERENCE TO RELATED APPLICATION

The present application claims priority under 35 U.S.C. § 119 (a) to Korean Patent Application No. 10-2024-0109802, filed on Aug. 16, 2024, which is incorporated herein by reference in its entirety.

### BACKGROUND

### 1. Technical Field

Embodiments of the present disclosure each generally relate to a semiconductor device that reduces crosstalk noise.

### 2. Related Art

The parallel interface of a high bandwidth memory (HBM) device includes a relatively large number of data lines, and it is desirable to minimize crosstalk noise thereof.

Although inter-symbol interference (ISI) noise can be removed using an equalizer, it may be difficult to fundamentally remove crosstalk noise even with the equalizer.

Accordingly, a technology has been proposed to provide crosstalk noise by coding data transmitted through a relatively large number of data lines.

For example, a Crosstalk Avoidance Codes (CAC) technique based on the Fibonacci sequence has been proposed.

These eliminate the factor that has the greatest effect on crosstalk noise by preventing three consecutive bits from transitioning.

However, these conventional coding techniques have a relatively large overhead due to the addition of bits, making it difficult to apply them to devices with large bandwidths such as a HBM device.

In addition, the existing coding techniques is optimized for a specific interface structure, so they are not desirable for removing crosstalk noise when they are applied to HBM as is.

Moreover, the existing coding techniques assume that only one factor, either capacitive coupling or inductive coupling, is significant in affecting crosstalk noise, without accounting for both effects simultaneously. This limitation undermines the general applicability of the approach.

### SUMMARY

In accordance with an embodiment of the present disclosure, a semiconductor device may include a first encoding circuit configured to encode data to generate encoding data including one or more symbol groups, each of the symbol groups including an upper symbol and a lower symbol; and a second encoding circuit configured to generate transmission data by performing an operation on previous transmission data and the encoding data. The first encoding circuit encodes the data to prevent a signal on each of one or more of aggressor lines from transitioning when a signal on a victim line transitions. A plurality of data lines of the semiconductor device are arranged in a grid pattern, the victim line is a data line included in an inner row among the plurality of data lines, and each of the aggressor lines is a data line located adjacent to the victim line. The upper symbol corresponds to the victim line and the lower symbol corresponds to the aggressor lines.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIG. 1 illustrates a semiconductor device according to an embodiment of the present disclosure.

FIG. 2 illustrates an encoding circuit according to an embodiment of the present disclosure.

FIG. 3 illustrates an arrangement of data lines and an operation of an encoding circuit according to an embodiment of the present disclosure.

FIG. 4 illustrates a first encoding circuit according to an embodiment of the present disclosure.

FIG. 5 illustrates a lookup table included in a bit encoding circuit and an operation thereof according to an embodiment of the present disclosure.

FIGS. 6, 7, 8, and 9 illustrate an operation of an encoding circuit according to an embodiment of the present disclosure.

### DETAILED DESCRIPTION

The following detailed description references the accompanying figures in describing illustrative embodiments consistent with this disclosure. These embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of various embodiments of the present disclosure is defined in accordance with claims and equivalents thereof. Also, throughout the specification, reference to “an embodiment” or the like is not necessarily to only one embodiment, and different references to any such phrase are not necessarily to the same embodiment(s).

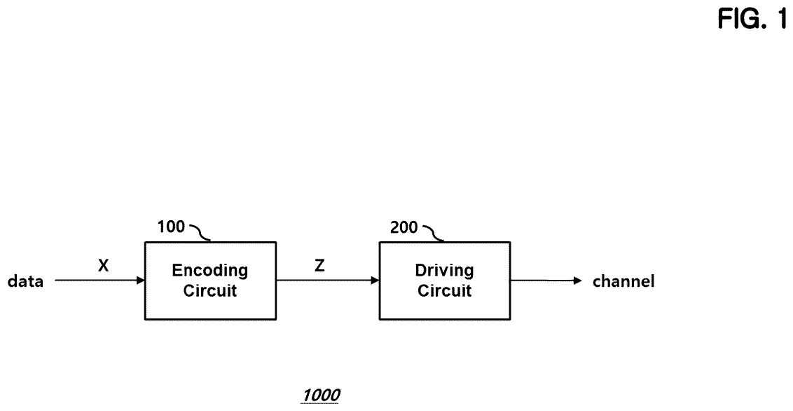

FIG. 1 is a block diagram showing a semiconductor device 1000 according to one embodiment of the present disclosure.

The semiconductor device 1000 includes an encoding circuit 100 that receives data X and generates transmission data Z and a driving circuit 200 that drives a channel to transmit the transmission data Z.

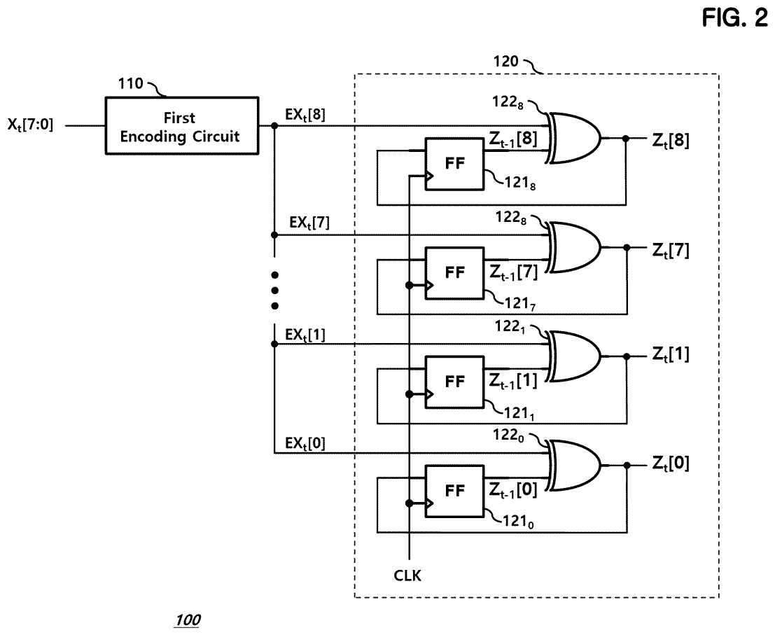

FIG. 2 is a block diagram showing the encoding circuit 100 according to an embodiment of the present disclosure.

The encoding circuit 100 includes a first encoding circuit 110 and a second encoding circuit 120.

The first encoding circuit 110 receives data Xₜ and generates encoding data EXₜ.

The subscript t in the symbol indicates a current time.

The second encoding circuit 120 generates current transmission data Zₜ using the encoding data EXₜ and previous transmission data Zₜ₋₁ transmitted at a previous time. For example, the previous time t−1 may be a time immediately preceding the current time t by a predetermined time interval.

In the following disclosure, it is assumed that data includes 8 bits, and both encoding data and transmission data include 9 bits, but the number of bits thereof may vary according to embodiments.

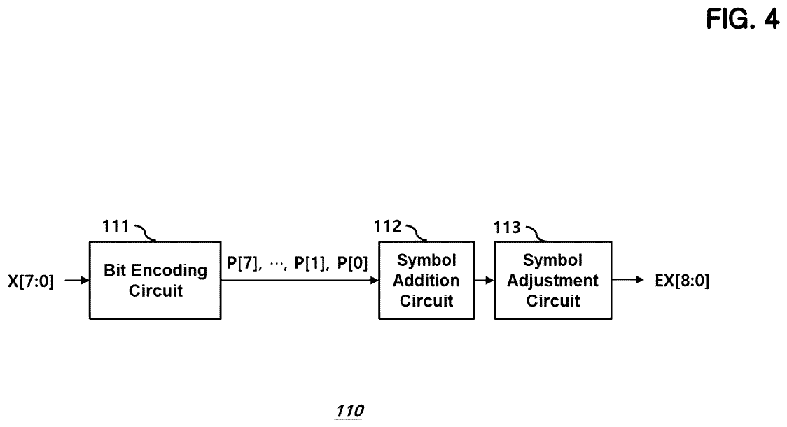

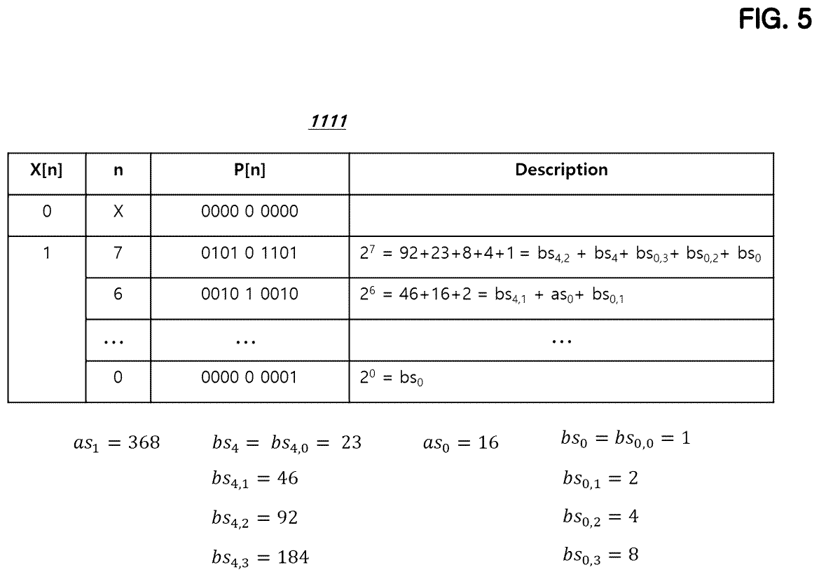

A specific configuration and operation of the first encoding circuit 110 will be described below in more detail with reference to FIGS. 4 and 5.

The second encoding circuit 120 includes one or more of flip-flops 121 and one or more of logical operation circuits (e.g., a plurality of XOR operation circuits) 122.

A subscript in each of the reference numbers referring to the flip-flops 121 and the XOR operation circuits 122 represents a corresponding bit number.

The plurality of flip-flops 121 provide the previous transmission data Zₜ₋₁ from the transmission data Zₜ. Specifically, each of the plurality of flip-flops 121 provides a corresponding bit of the previous transmission data Zₜ₋₁ to a corresponding one of the XOR operation circuits 122 in response to a clock signal CLK.

The XOR operation circuit 122 performs an XOR operation on the encoding data EXₜ and the previous transmission data Zₜ₋₁ to generate the current transmission data Zₜ. Specifically, each of the XOR operation circuits 122 performs an XOR operation on a corresponding bit of the encoding data EXₜ and a corresponding bit of the previous transmission data Zₜ₋₁ to generate a corresponding bit of the current transmission data Zₜ.

For example, the XOR operation circuit 1228 corresponding to the 8th bit generates the 8th bit Zₜ[8] of the current transmission data Zₜ by performing an XOR operation on the 8th bit EXₜ[8] of the encoding data EXₜ and the 8th bit Z_{t-1 [8}] of the previous transmission data Zₜ₋₁.

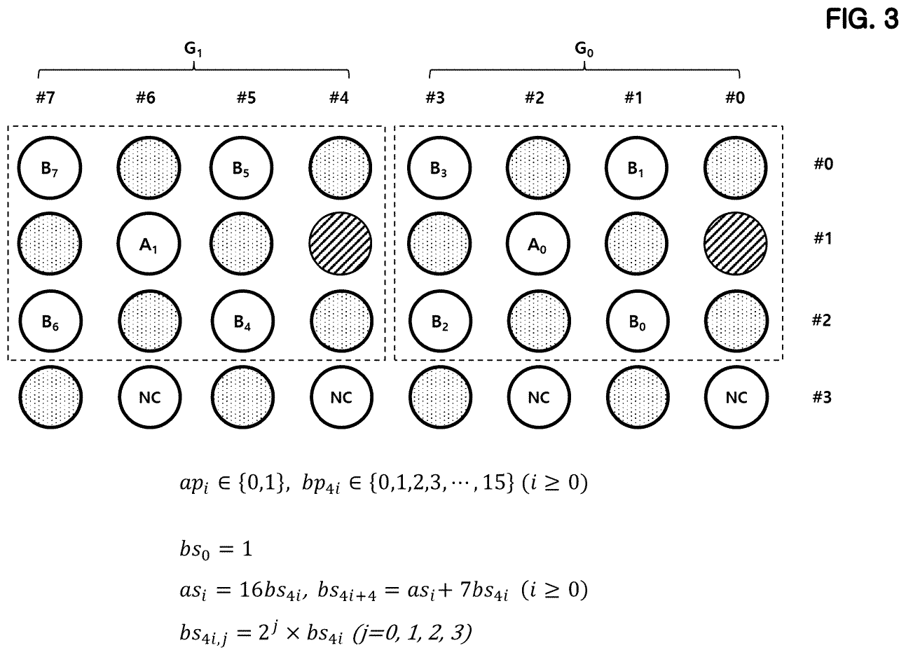

FIG. 3 illustrates an arrangement of data lines and an operation of the encoding circuit 100 according to an embodiment of the present disclosure.

FIG. 3 illustrates data lines used in a high bandwidth memory (HBM) device as an example, where a data line having solid white pattern represents a data line through which data is transmitted, and a data line having a dot pattern represents a ground line. For example, the data lines may be used to transmit the transmission data Z therethrough in the HBM device.

A data line having a diagonal pattern in FIG. 3 is used as a data line in a conventional HBM device, but is used as a ground line in the embodiment of FIG. 3.

In the embodiment of FIG. 3, a plurality of data lines are arranged in a grid pattern including four rows and eight columns.

Hereinafter, row numbers are indicated as #0, #1, #2, and #3 from top to bottom, and column numbers are indicated as #0, #1, #2, #3, #4, #5, #6, and #7 from right to left.

In the embodiment of FIG. 3, the encoding data EX is arranged in units of 3 rows and 4 columns. That is, the encoding data EX is arranged in units of 12 data lines included between row #0 and row #2 and between column #0 and column #4.

In an embodiment, additional data lines that transmit unencoded data may further be included. For example, these additional data lines correspond to row #3 in FIG. 3, and unencoded data may be transmitted through data lines indicated as NC.

Determining which part of the entire data to encode and which parts not to encode can vary according to embodiments. Moreover, the technique for transmitting unencoded data can also be modified by a person skilled in the art referring to the present disclosure.

Accordingly, the following disclosure focuses on the technology for transmitting parts to be encoded of the entire data, and it is assumed that the data X refers to the parts to be encoded.

Among the data lines indicated in FIG. 3, inner rows are more affected by crosstalk noise than outer rows. That is, rows #1 and #2 are more affected by crosstalk noise than rows #0 and #3. For example, the outer rows may be defined as a pair of outermost rows (e.g., rows #0 and #3 in FIG. 3) in the grid pattern, and the inner rows may be defined as the remaining rows (e.g., rows #1 and #2) disposed within the outermost rows in the grid pattern. However, embodiments of the present disclosure are not limited thereto, and the number of inner rows and the number of outer rows may vary according to embodiments.

In the embodiment of FIG. 3, a data line corresponding to row #1 of column #0 is added as a ground line, so a data line of row #1 and column #2 is most affected by crosstalk noise.

As shown in FIG. 3, a symbol group is formed based on three rows and four columns in the embodiment. The influence of crosstalk noise is reduced when a data line corresponding to a victim line, i.e., row #1 and column #2, which is most affected by crosstalk noise within a symbol group, transitions.

For example, the 0th symbol group G₀ is formed using the data lines from column #0 to column #3 and from row #0 to row #2, and the 1st symbol group G₁ is formed using the data lines from column #4 to column #7 and from row #0 to row #2.

In an embodiment, the encoding data EX includes one or more of symbol groups (e.g., 0^{th} symbol group G₀ and 1st symbol group G₁ in FIG. 3), each of the symbol groups including an upper symbol and a lower symbol. For example, a symbol group Gᵢ includes an upper symbol apᵢ and a lower symbol bp₄ᵢ, where i represents a symbol group number and is an integer greater than or equal to 0.

The i-th upper symbol apᵢ included in the i-th symbol group Gᵢ is a 1-bit symbol with a value of 0 or 1, and the i-th lower symbol bp₄ᵢ included in the i-th symbol group Gᵢ is a 4-bit symbol with a value of one of the integers from 0 to 15.

Taking the 0th symbol group G₀ as an example, the upper symbol ap₀ corresponds to a data line A₀ corresponding to the 1st row and the 2nd column, and the lower symbol bp₀ corresponds to four data lines B₀, B₁, B₂, and B₃ corresponding to rows #0 and #2 in the columns #1 and #3.

At this time, the data line A₀ corresponding to the upper symbol ap₀ corresponds to a victim line, and the four data lines B₀, B₁, B₂, B₃ corresponding to the lower symbol bp₀ correspond to aggressor lines that provide crosstalk noise to the victim line.

In this embodiment, basis values of symbols can be expressed as in Equation 1:

$${bs}_{0} = 1 , {as}_{i} = 16 {bs}_{4 i} , {bs}_{4 i + 4} = {as}_{i} + 7 {bs}_{4 i} ( i \geq 0 ) \qquad [ Equation 1 ]$$

$${bs}_{4 i , j} = {2}^{j} \times {bs}_{4 i} ( j = 0 , 1 , 2 , 3 )$$

In Equation 1, asᵢ represents the basis value of the i-th upper symbol included in the i-th symbol group Gᵢ, and bs₄ᵢ represents the basis value of the i-th lower symbol included in the i-th symbol group Gᵢ.

bs_{4i,j} represents the j-th bit among the 4 bits included in the i-th lower symbol, that is, the basis value corresponding to the j-th data line. For example, bs_{0,3} represents the basis value corresponding to the data line B₃ in FIG. 3.

Table 1 below shows the basis values generated by Equation 1.

TABLE 1

| | | | |
|---|---|---|---|
| bs₀ | 1 | bs₄ | 23 |
| bs_{0, 1} | 2 | bs_{4, 1} | 46 |
| bs_{0, 2} | 4 | bs_{4, 2} | 92 |
| bs_{0, 3} | 8 | bs_{4, 3} | 184 |
| as₀ | 16 | as₁ | 368 |

The first encoding circuit 110 encodes data X using the relationships according to Equation 1.

This ensures that a victim line is less affected by crosstalk noise provided by aggressor lines.

More specifically, in an embodiment, when the victim line transitions, encoding is performed to prevent one or more (e.g., three or more) aggressor lines from transitioning together, which will be disclosed in detail below.

In an embodiment, bits from the 0th bit of the encoding data EX are sequentially assigned to data lines of the lower symbol(s) and a data line of the upper symbol.

For example, when allocating bits #0 to #8 of the encoding data EX, they are assigned to the data lines in sequence of B₀, B₁, B₂, B₃, A₀, B₄, B₅, B₆, and B₇.

Hereinafter, a method for generating 9-bit encoding data EX from 8-bit data X according to an embodiment of the present disclosure will be described in more detail.

As aforementioned, 8-bit data X refers to a portion of the entire data on which encoding is performed, and the entire data may further include data bits on which encoding is not performed.

FIG. 4 is a block diagram showing the first encoding circuit 110 according to an embodiment of the present disclosure.

The first encoding circuit 110 includes a bit encoding circuit 111 and a symbol addition circuit 112, and may further include a symbol adjustment circuit 113.

The bit encoding circuit 111 generates a plurality of encoding vectors P[n] each corresponding to each bit of data X, where n is a bit number from 0 to 7. At this time, each encoding vector P[n] includes 9 bits.

The bit encoding circuit 111 can include a lookup table 1111 to look up an encoding vector corresponding to each bit of data X. For example, the lookup table 1111 stores a precalculated plurality of encoding vectors each corresponding to a value (e.g., 0 or 1) and a bit number n (e.g., 0 to 7) of a corresponding one of a plurality of bits included in the data X.

FIG. 5 shows the structure of the lookup table 1111 and method for generating the lookup table 1111.

FIG. 5 shows a method of generating an encoding vector corresponding to each bit of data.

When X[n]=0, the encoding vector P[n] is “0000 0 0000” regardless of n.

When X[7]=1, since X[7]=128=bs_{4,2}+bs₄+bs_{0,3}+bs_{0,2}+bs₀, the encoding vector P[7] is “0101 0 1101.”

When X[6]=1, since X[6]=64=bs_{4,1}+as₀+bs_{0,1}, the encoding vector P[6] is “0010 1 0010.”

In this way, encoding vectors respectively corresponding to bit values and bit numbers can be determined in advance and stored in the lookup table 1111.

The symbol addition circuit 112 adds multiple encoding vectors symbol by symbol.

For example, the symbol addition circuit 112 adds 0th symbols of multiple encoding vectors to output 0th symbol, and adds 1st symbols to output 1st symbol.

In this embodiment, since the upper symbol includes 1 bit, a 1-bit addition is performed with the upper symbols, and since the lower symbol includes 4 bits, a 4-bit addition operation is performed with the lower symbols.

In this embodiment, each upper symbol must have a value of 0 or 1, and the lower symbol must have a value of one of the integers from 0 to 15, but a value output as a result of symbol-wise addition using multiple encoding vectors may be out of a given range (e.g., an allowed range from 0 to 1 or from 0 to 15).

The symbol adjustment circuit 113 adjusts the value output from the symbol addition circuit 112 to ensure that each symbol's value is in a given range (e.g., an allowed range).

The symbol adjustment circuit 113 adjusts the value of each symbol from the value output from the symbol addition circuit 112 so that each symbol has an allowed value.

At this time, the symbol adjustment circuit 113 adjusts the symbol value by referring to the relationship in Equation 1.

For example, an operation to adjust the upper symbol #1 apᵢ will be described below.

Below, bp_{0,3}, bp_{0,2}, bp_{0,1}, bp_{0,0} represent four bits included in the lower symbol #0 bp₀. For example, if {bp_{0,3}, bp_{0,2}, bp_{0,1}, bp_{0,0}}={1, 1, 1, 1}, then the lower symbol #0 bp₀ has a value of 15.

[Condition 1] If the value of bp₄ is greater than or equal to 16, then according to the relationship as₁=16bs₄, the value of ap₁ should be increased by 1, and the value of bp₄ should be decreased by 16.

[Condition 2] If condition 1 is not satisfied, the value of bp₄ is greater than or equal to 15, and the value of ap₀ is greater than or equal to 2, then according to the relationship as₁=16bs₄=15bs₄+2as₀−9bs₀, the value of ap₁ should be increased by 1, the value of bp₄ should be decreased by 15, the value of ap₀ should be decreased by 2, and the value of bp₀ should be increased by 9.

The adjustment operation is repeated until both conditions 1 and 2 are not satisfied, and the adjustment for the upper symbol #1 ap₁ is completed.

Once the adjustment for upper symbol #1 ap₁ is completed, adjustment for the lower symbol #1 bp₄ is performed.

[Condition 3] If the value of ap₀ is greater than or equal to 1, and the value of bp₀ is greater than or equal to 7, then according to the relationship bs₄=as₀+7bs₀ based on Equation 1, the value of ap₀ should be decreased by 1, and the value of bp₀ should be decreased by 7.

[Condition 4] If condition 3 is not satisfied, and the value of bp₀ is greater than or equal to 23, then the value of bp₄ should be increased by 1, and the value of bp₀ should be decreased by 23 because of the relationship bs₄₌₂₃bs₀.

Once the adjustment for lower symbol #1 bp₄ is completed, adjustments are performed sequentially for the upper symbol #0 ap₀ and the lower symbol #0 bp₀ in a similar manner. Therefore, detailed description thereof will not be repeated for the interest of brevity.

By performing this operation, the symbol adjustment circuit 113 outputs 9-bit encoding data EX.

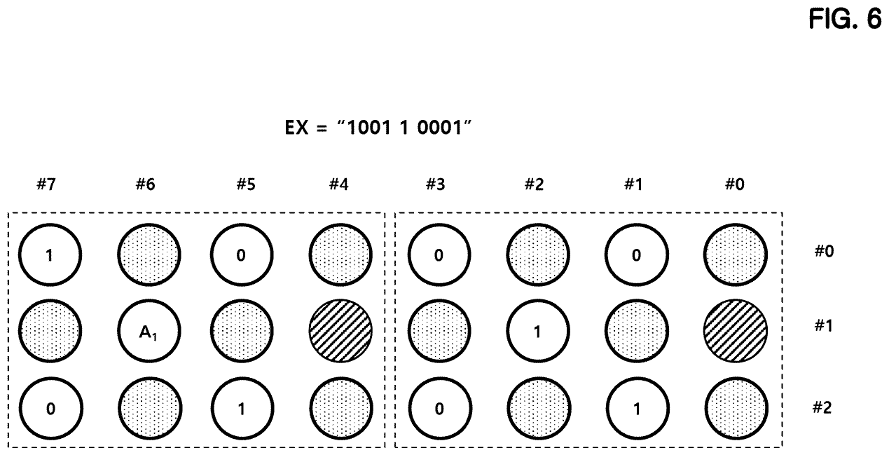

FIG. 6 illustrates an example in which the encoding data EX is “1001 1 0001” and is allocated to multiple data lines. In FIG. 6, row #3 in FIG. 3 for transmitting unencode data is omitted for the interest of brevity.

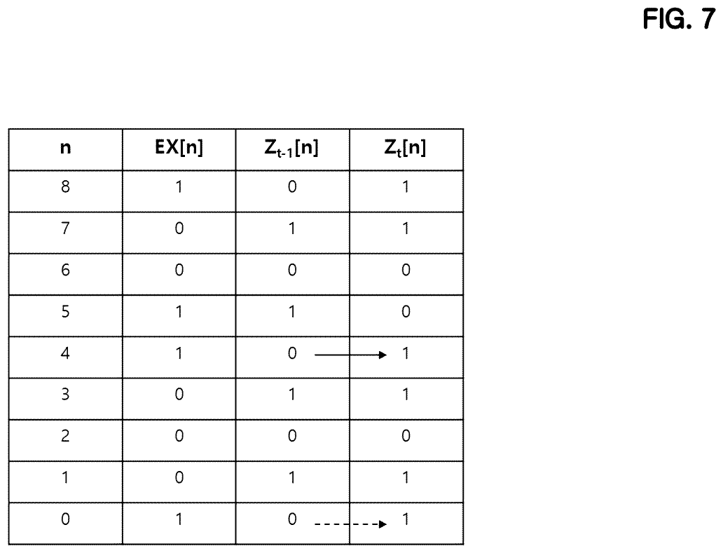

FIG. 7 is a diagram illustrating an operation of the second encoding circuit 120 according to an embodiment of the present disclosure.

In FIG. 7, the previous transmission data Zₜ₋₁ is assumed to be “0101 0 1010.”

Since the transmission data Zₜ corresponds to the result of the XOR operation on the previous transmission data Zₜ₋₁ and the encoding data EX, the transmission data Zₜ is “1100 1 1011.”

Since EX[4] corresponds to a victim line and EX[3:0] corresponds to aggressor lines, we can see that when a signal on the victim line transitions, only one signal among the four signals of the four aggressor lines transitions.

The driving circuit 200 drives multiple data lines included in the channel using the transmission data Zₜ determined in this manner.

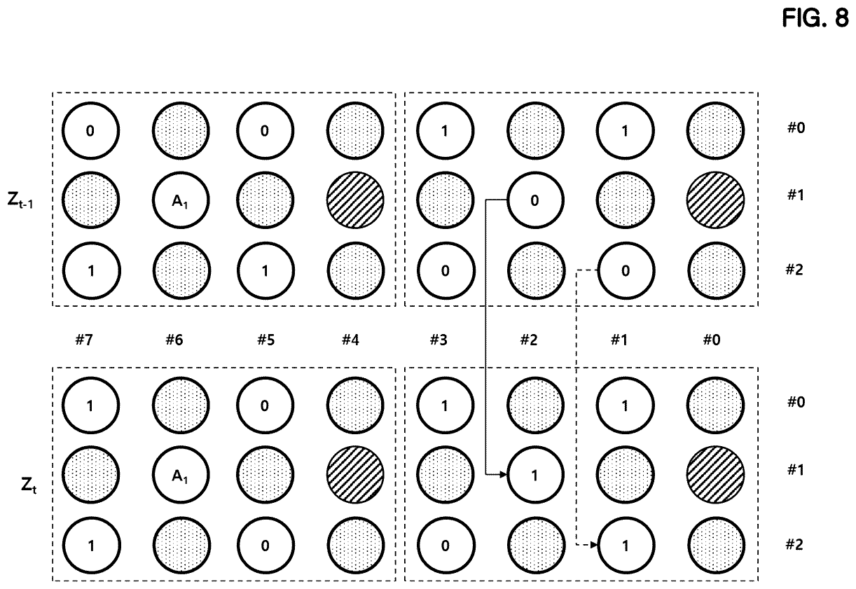

FIG. 8 shows the previous transmission data Zₜ₋₁ and the current transmission data Zₜ of FIG. 7 together, where the transition of the victim line is indicated by a solid line and the transition of the aggressor line is indicated by a dotted line. In other words, FIG. 8 shows that a signal on the victim transitions from a logic low value (e.g., “0”) to a logic high value (e.g., “1”) as indicated by a solid line, and a signal on the aggressor line transitions from a logic low value to a logic high value as indicated by a dotted line.

As aforementioned, in this embodiment, when the victim line transitions, the number of transitioning lines among the four aggressor lines is minimized to reduce the crosstalk noise applied to the victim line. This will be described in detail below.

When performing encoding while satisfying the relationships in Equation 1, there is no case where at least three of the data lines B₄ᵢ, B₄ᵢ₊₁, B₄ᵢ₊₂, and B₄ᵢ₊₃ in the encoding data EX are 1 when the data line Aᵢ is 1.

For example, when i=0, the relationship bs₄=as₀₊₇bs₀ is established based on the Equation 1.

Since 7bs₀=bs₀+2 bs₀+4 bs₀=bs₀+bs_{0,1}+bs_{0,2}, a carry to a data line B₄ occurs when at least three of the data lines B₀, B₁, B₂, and B₃ are 1 under the condition of A₀=1.

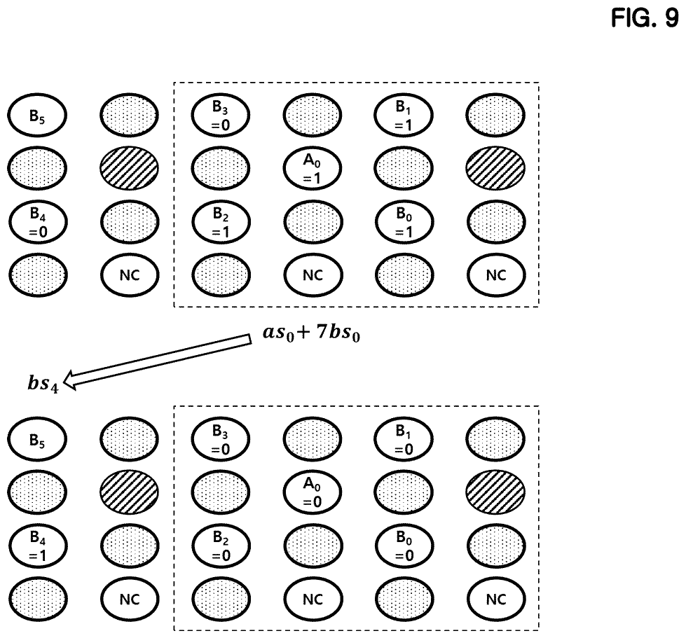

FIG. 9 illustrates the carry to B₄ occurring when B₀=1, B₁=1, B₂=1, and B₃=0 under the condition of A₀=1.

As aforementioned, the current transmission data Zₜ corresponds to the result of the XOR operation of the previous transmission data Zₜ₋₁ and the encoding data EX.

That is, in order for a transition to occur between the previous transmission data Zₜ₋₁ and the current transmission data Zₜ, the value of the encoding data EX at the corresponding position must be a log iv high value (e.g., “1”).

As aforementioned, there cannot be a case where at least three values of the encoding data corresponding to the aggressor lines are 1 when the value of the encoding data corresponding to the victim line is 1.

Therefore, in embodiments of the present disclosure, when a victim line transitions, the number of aggressor lines transitioning at the same time can be limited to a maximum of 2, thereby suppressing crosstalk noise. In other words, crosstalk noise at a victim line (e.g., Aᵢ) by aggressor lines (e.g., B₄ᵢ, B₄ᵢ₊₁, B₄ᵢ₊₂, and B₄ᵢ₊₃) located adjacent thereto may be significantly reduced, compared to when a signal on the victim line and a signal on each of three or more of adjacent aggressor lines transition simultaneously. In an embodiment, the first encoding circuit 110 may encode data X to prevent a signal on each of one or more of the aggressor lines from transitioning when a signal on the victim line transitions. For example, the first encoding circuit 110 may perform an encoding operation to prevent one or more of a value corresponding to a victim line and values of at least three aggressor lines from having a logic high value (e.g., “1”) simultaneously. As used herein, including in the claims, “and” as used in a list of items prefaced by a phrase (e.g., “one or more of” or “one or both of”) indicates an inclusive list such that, for example, a list of one or more of A, B, and C indicates A or B or C or AB or AC or BC or ABC (i.e., A and B and C).

In this way, embodiments of the present disclosure can prevent the worst crosstalk noise from occurring regardless of whether the type of crosstalk noise is capacitive or inductive.

In an embodiment, a method of operating a semiconductor device includes encoding data to generate encoding data including one or more symbol groups to prevent a signal on each of one or more of aggressor lines from transitioning when a signal on a victim line transitions; and generating transmission data by performing an operation on previous transmission data and the encoding data. A plurality of data lines of the semiconductor device are arranged in a grid pattern, the victim line is a data line included in an inner row among the plurality of data lines, and each of the aggressor lines is a data line located adjacent to the victim line. Each of the symbol groups includes an upper symbol and a lower symbol, and the upper symbol corresponds to the victim line and the lower symbol corresponds to the aggressor lines.

In an embodiment, encoding the data includes generating a plurality of encoding vectors corresponding to a plurality of bits included in the data and generating the encoding data by performing symbol-wise addition on the plurality of encoding vectors.

In an embodiment, the method further includes storing a precalculated plurality of encoding vectors each corresponding to a value and a bit number of a corresponding one of the plurality of bits included in the data.

In an embodiment, the encoding data is generated by adjusting a value of a symbol among a plurality of symbols that have been obtained from performing the symbol-wise addition on the plurality of encoding vectors, to ensure that the value of the symbol is in a given range.

In an embodiment, generating the transmission data includes generating the previous transmission data by latching the transmission data and generating the transmission data by performing a bitwise logical operation on the previous transmission data and the encoding data.

In an embodiment, the logical operation is an XOR operation, and encoding the data includes performing an encoding operation based on a relationship between a plurality of base values corresponding to the upper symbol and the lower symbol. The relationship is set to prevent one or more of a value corresponding to the victim line and values of at least three of the aggressor lines from having a logic high value simultaneously.

In an embodiment, each of the symbol groups corresponds to a portion of the plurality of data lines, the portion of the plurality of data lines being arranged in 3 rows and 4 columns, and the aggressor lines are four data lines adjacent to the victim line. A base value asᵢ corresponding to the upper symbol and a base value bs₄ᵢ corresponding to the lower symbol have the relationship as follows: bs₀=1, asᵢ=16bs₄ᵢ, bs₄ᵢ+4=asᵢ+7bs₄ᵢ (i≥0), bs_{4i,j}=2^{j}×bs₄ᵢ (j=0, 1, 2, 3), where i is a symbol group number and j is a data line number in a lower symbol included in an i-th symbol group.

In an embodiment, one or more data lines other than the victim line and the aggressor lines among the plurality of data lines are grounded.

In an embodiment, the plurality of data lines further includes an additional row of data lines adjacent to the corresponding symbol group, and the method further includes transmitting unencoded data through the additional row of data lines.

In an embodiment, the plurality of data lines transmit the transmission data in a high bandwidth memory (HBM) device.

Although various embodiments have been illustrated and described above, various changes and modifications may be made to the above-described embodiments.

What is claimed is:

1. A semiconductor device comprising:
a first encoding circuit configured to encode data to generate encoding data including one or more symbol groups, each of the symbol groups including an upper symbol and a lower symbol; and
a second encoding circuit configured to generate transmission data by performing an operation on previous transmission data and the encoding data,
wherein the first encoding circuit encodes the data to prevent a signal on each of one or more of aggressor lines from transitioning when a signal on a victim line transitions,
wherein a plurality of data lines of the semiconductor device are arranged in a grid pattern, the victim line is a data line included in an inner row among the plurality of data lines, and each of the aggressor lines is a data line located adjacent to the victim line, and
wherein the upper symbol corresponds to the victim line and the lower symbol corresponds to the aggressor lines.

2. The semiconductor device of claim 1, wherein the first encoding circuit includes:
a bit encoding circuit configured to generate a plurality of encoding vectors corresponding to a plurality of bits included in the data; and
a symbol addition circuit configured to generate the encoding data by performing symbol-wise addition on the plurality of encoding vectors.

3. The semiconductor device of claim 2, wherein the bit encoding circuit includes a lookup table storing a precalculated plurality of encoding vectors each corresponding to a value and a bit number of a corresponding one of the plurality of bits included in the data.

4. The semiconductor device of claim 2, further comprising a symbol adjustment circuit configured to generate the encoding data by adjusting a value of a symbol among a plurality of symbols output from the symbol addition circuit to ensure that the value of the symbol is in a given range.

5. The semiconductor device of claim 1, wherein the second encoding circuit includes:
one or more flip-flops configured to generate the previous transmission data by latching the transmission data; and
one or more logical operation circuits configured to generate the transmission data by performing a bitwise logical operation on the previous transmission data and the encoding data.

6. The semiconductor device of claim 5, wherein the logical operation circuits of the second encoding circuit are XOR operation circuits,
wherein the first encoding circuit performs an encoding operation based on a relationship between a plurality of base values corresponding to the upper symbol and the lower symbol, and
wherein the relationship is set to prevent one or more of a value corresponding to the victim line and values of at least three of the aggressor lines from having a logic high value simultaneously.

7. The semiconductor device of claim 6, wherein each of the symbol groups corresponds to a portion of the plurality of data lines, the portion of the plurality of data lines being arranged in 3 rows and 4 columns,
wherein the aggressor lines are four data lines adjacent to the victim line, and
wherein a base value asᵢ corresponding to the upper symbol and a base value bs₄ᵢ corresponding to the lower symbol have the relationship as follows: bs₀=1, asᵢ=16bs₄ᵢ, bs₄ᵢ₊₄=asᵢ+7bs₄ᵢ (i≥0), bs_{4i,j}=2^{j}×bs₄ᵢ (j=0, 1, 2, 3), where i is a symbol group number and j is a data line number in a lower symbol included in an i-th symbol group.

8. The semiconductor device of claim 7, wherein one or more data lines other than the victim line and the aggressor lines among the plurality of data lines are grounded.

9. The semiconductor device of claim 8, wherein the plurality of data lines further includes an additional row of data lines adjacent to the corresponding symbol group, and the additional row of data lines transmit unencoded data.

10. The semiconductor device of claim 1, wherein the plurality of data lines transmit the transmission data in a high bandwidth memory (HBM) device.

11. A method of operating a semiconductor device, comprising:
encoding data to generate encoding data including one or more symbol groups to prevent a signal on each of one or more of aggressor lines from transitioning when a signal on a victim line transitions; and
generating transmission data by performing an operation on previous transmission data and the encoding data,
wherein a plurality of data lines of the semiconductor device are arranged in a grid pattern, the victim line is a data line included in an inner row among the plurality of data lines, and each of the aggressor lines is a data line located adjacent to the victim line, and
wherein each of the symbol groups includes an upper symbol and a lower symbol, and the upper symbol corresponds to the victim line and the lower symbol corresponds to the aggressor lines.

12. The method of claim 11, wherein encoding the data comprises:
generating a plurality of encoding vectors corresponding to a plurality of bits included in the data; and
generating the encoding data by performing symbol-wise addition on the plurality of encoding vectors.

13. The method of claim 12, further comprising storing a precalculated plurality of encoding vectors each corresponding to a value and a bit number of a corresponding one of the plurality of bits included in the data.

14. The method of claim 12, wherein the encoding data is generated by adjusting a value of a symbol among a plurality of symbols that have been obtained from performing the symbol-wise addition on the plurality of encoding vectors, to ensure that the value of the symbol is in a given range.

15. The method of claim 11, wherein generating the transmission data comprises:
generating the previous transmission data by latching the transmission data; and
generating the transmission data by performing a bitwise logical operation on the previous transmission data and the encoding data.

16. The method of claim 15, wherein the logical operation is an XOR operation,
wherein encoding the data comprises performing an encoding operation based on a relationship between a plurality of base values corresponding to the upper symbol and the lower symbol, and
wherein the relationship is set to prevent one or more of a value corresponding to the victim line and values of at least three of the aggressor lines from having a logic high value simultaneously.

17. The method of claim 16, wherein each of the symbol groups corresponds to a portion of the plurality of data lines, the portion of the plurality of data lines being arranged in 3 rows and 4 columns, wherein the aggressor lines are four data lines adjacent to the victim line, and
wherein a base value asᵢ corresponding to the upper symbol and a base value bs₄ᵢ corresponding to the lower symbol have the relationship as follows: bs₀=1, asᵢ=16bs₄ᵢ, bs₄ᵢ₊₄=asᵢ+7bs₄ᵢ (i≥0), bs_{4i,j}=2^{j}×bs₄ᵢ (j=0, 1, 2, 3), where i is a symbol group number and j is a data line number in a lower symbol included in an i-th symbol group.

18. The method of claim 17, wherein one or more data lines other than the victim line and the aggressor lines among the plurality of data lines are grounded.

19. The method of claim 18, wherein the plurality of data lines further includes an additional row of data lines adjacent to the corresponding symbol group, the method further comprising transmitting unencoded data through the additional row of data lines.

20. The method of claim 11, wherein the plurality of data lines transmit the transmission data in a high bandwidth memory (HBM) device.
